(19) United States
(12) Patent Application Publication
(10) Pub. No.: US 2025/0266914 A1
(43) Pub. Date: Aug. 21, 2025

(54) Uplink Receiver Processing in Extreme Massive Multi-User Multiple Input Multiple Output Systems

(71) Applicant: Nokia Solutions and Networks Oy, Espoo (FI)

(72) Inventors: Pavan Koteshwar, Orsay (FR); Sivarama VENKATESAN, West Orange, NJ (US)

(21) Appl. No.: 18/857,583

(22) PCT Filed: Apr. 21, 2022
(86) PCT No.: PCT/EP2022/060523

§ 371 Date: Oct. 17, 2024

(51) Int. Cl. H04B 17/345; H04B 7/06; H04B 17/309

(52) U.S. Cl. CPC H04B 17/345; H04B 7/0617; H04B 17/346

(57) ABSTRACT

Systems, methods. apparatuses. and computer program products for receiver processing, such as uplink receiver processing in massive multi-user multiple input multiple output systems are provided. For example. a method may include estimating interference plus noise covariance of a received signal. The method may also include performing noise whitening of the received signal. The method may further include performing beamforming on the whitened received signal.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing receiver processing, such as uplink receiver processing in massive multi-user multiple input multiple output systems.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform estimating interference plus noise covariance of a received signal. The at least one memory and computer program code can also be configured, with the at least one processor, to cause the apparatus at least to perform noise whitening of the received signal. The at least one memory and computer program code can further be configured, with the at least one processor, to cause the apparatus at least to perform beamforming on the whitened received signal.

An embodiment may be directed to a method. The method can include estimating interference plus noise covariance of a received signal. The method can also include performing noise whitening of the received signal. The method can further include performing beamforming on the whitened received signal.

An embodiment may be directed to an apparatus. The apparatus can include means for estimating interference plus noise covariance of a received signal. The apparatus can also include means for performing noise whitening of the received signal. The apparatus can further include means for performing beamforming on the whitened received signal.

### BRIEF DESCRIPTION OF THE DRAWINGS

For proper understanding of example embodiments, reference should be made to the accompanying drawings, wherein:

FIG. 1 illustrates increasing multiple-input, multiple-output;

FIG. 2 illustrates an approach to using beamforming to improve channel estimation;

FIG. 3 illustrates an approach according to certain embodiments;

FIG. 4 illustrates a block diagram of a beamforming approach, according to certain embodiments;

FIG. 5 illustrates simulation results of a simulation of certain embodiments;

FIG. 6 illustrates an example flow diagram of a method, according to an embodiment; and

FIG. 7 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing receiver processing, such as uplink receiver processing in massive multi-user multiple input multiple output systems, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

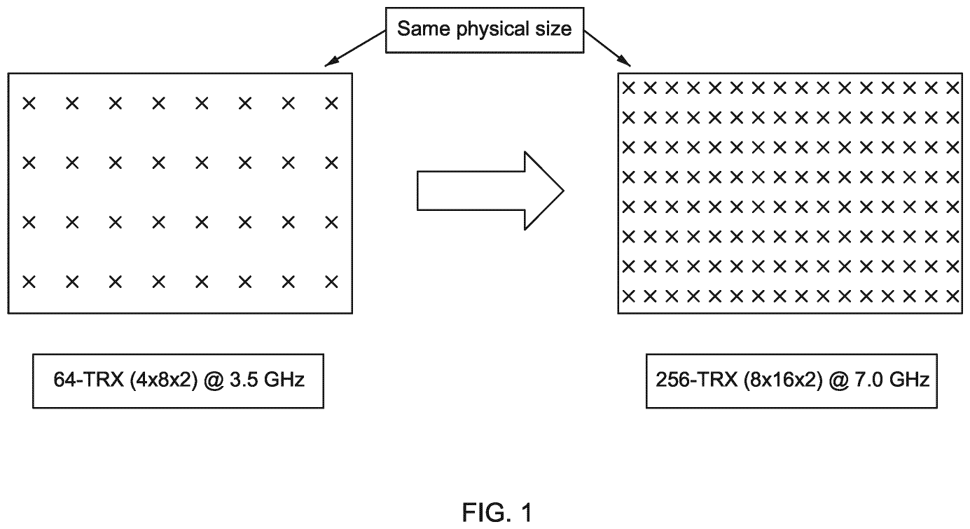

FIG. 1 illustrates increasing multiple-input, multiple-output. As shown in FIG. 1, one way to upgrade an antenna array is to replace a 64-element transceiver (TRX) array with dimensions 4×8×2 and operating at 3.5 gigahertz (GHz) with a 256-element TRX array with dimensions 8×16×2 and operating at 7.0 GHz.

Certain embodiments may be applicable to sixth generation (6G), which may enable at least five times higher data-rates than fifth generation (5G). As a result, the base station (BS) or next generation Node B (gNB) may be equipped with a higher number of antenna elements (AE) that may be in the range 512-1024, as compared to around 192 for 5G. There may also be a larger number of transceivers, around 256-512 compared to 32-64 in 5G, and the frequency band of interest may be 7-20 GHz. FIG. 1 shows how a larger number of TRXs can be accommodated within the same-sized antenna array by shifting to a larger carrier frequency. As the number of TRXs grows, so may the complexity of signal-processing at the BS receiver. Certain embodiments may be of increasing value as the complexity of transceivers and signal-processing increases. The new array may have a greater number of TRXs with the same physical size.

Channel estimation in high dimensions can be computationally intensive. When a base station (BS) is equipped with a large number of TRXs, channel estimation can involve estimating a high-dimensional vector that comprises each column of the channel matrix. Estimating a high-dimensional vector may be more inaccurate than estimating its projection into a suitably chosen lower-dimensional subspace, for the same number of pilot reference signals. Therefore, beamforming is one option to reduce the dimensionality of the received signals. One beamforming technique is to linearly project the high-dimensional received signal obtained in the antenna space onto a lower-dimensional space, called a beamspace. This projection can be achieved by using a suitably designed matrix called the beamforming matrix. Once the dimensionality of the received signal has been reduced, channel estimation can be more accurately performed in this lower-dimensional space. The beamforming matrix can be chosen in a way such that all or most) of the energy of the desired signal is preserved while the interference is rejected in an efficient manner.

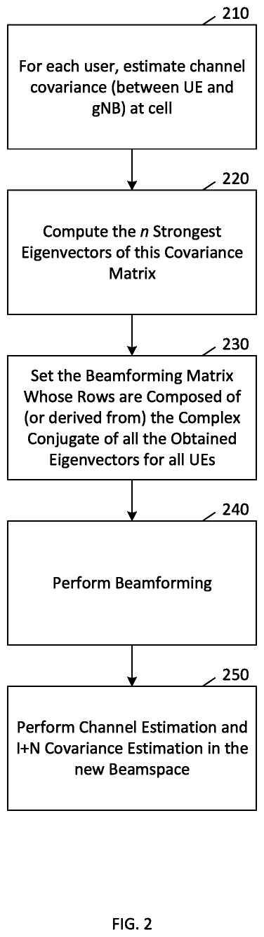

FIG. 2 illustrates an approach to using beamforming to improve channel estimation. As shown in FIG. 2, at 210, for each user the cell can estimate channel covariance between the user equipment and the base station or gNB. Next, at 220, the cell can compute the n strongest Eigenvectors of this covariance matrix. At 230, the cell can set the beamforming matrix whose rows are composed of or derived from the complex conjugate of all the obtained Eigenvectors for all UEs. At 240, the cell can perform beamforming. Furthermore, at 250, the cell can perform channel estimation and interference plus noise (I+N) covariance estimation in the new beamspace.

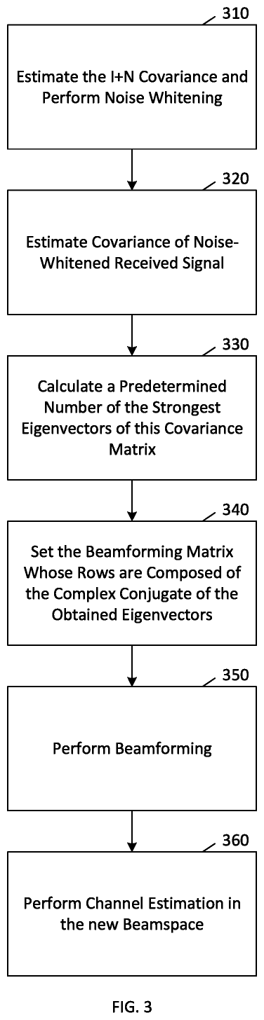

FIG. 3 illustrates an approach according to certain embodiments. At 310, the cell can estimate the covariance of interference plus noise and can perform noise whitening. The noise whitening can be a spatial whitening. At 320, the cell can estimate the covariance of the noise-whitened received signal.

At 330, the cell can calculate a predetermined number of the strongest Eigenvectors of the covariance matrix. More specifically, the cell can compute a pre-determined number of the strongest eigenvectors of the spatial-covariance matrix of the whitened received signal. The number is usually determined in relation to the total number of transmitting streams from all the users. At 340, the complex-conjugate of the computed eigenvectors form the rows of the beamforming matrix. More specifically, at 340 the cell can set the beamforming matrix whose rows are composed of the complex conjugates of the obtained Eigenvectors.

At 350, the cell can perform beamforming using the beamforming matrix to reduce the dimensionality of the received signal vectors. For example, the procedure at 350 can include left-multiplying all the whitened received signals by the beamforming matrix. The received signal may now be said to be in the beamspace. At 360, the cell can perform channel estimation and symbol detection in the lower-dimensional beamspace.

Thus, certain embodiments may involve performing noise whitening and then estimating covariance on the noise-whitened received signal. Accordingly, certain embodiments may be able to reject the interference while preserving all or most of the desired signal energy in a lower-dimensional space. Thus use of a lower dimensional received space may lead to a higher accuracy of channel estimation. It may also be valuable to reject the interference and preserve almost all of the energy of the desired signals. In an ideal scenario, certain embodiments would perfectly achieves both such goals. An additional advantage of certain embodiments may be that compared to the approach of FIG. 2, there may be no further need to recompute the I+N covariance, since the effective noise continues to be whitened in the beamspace.

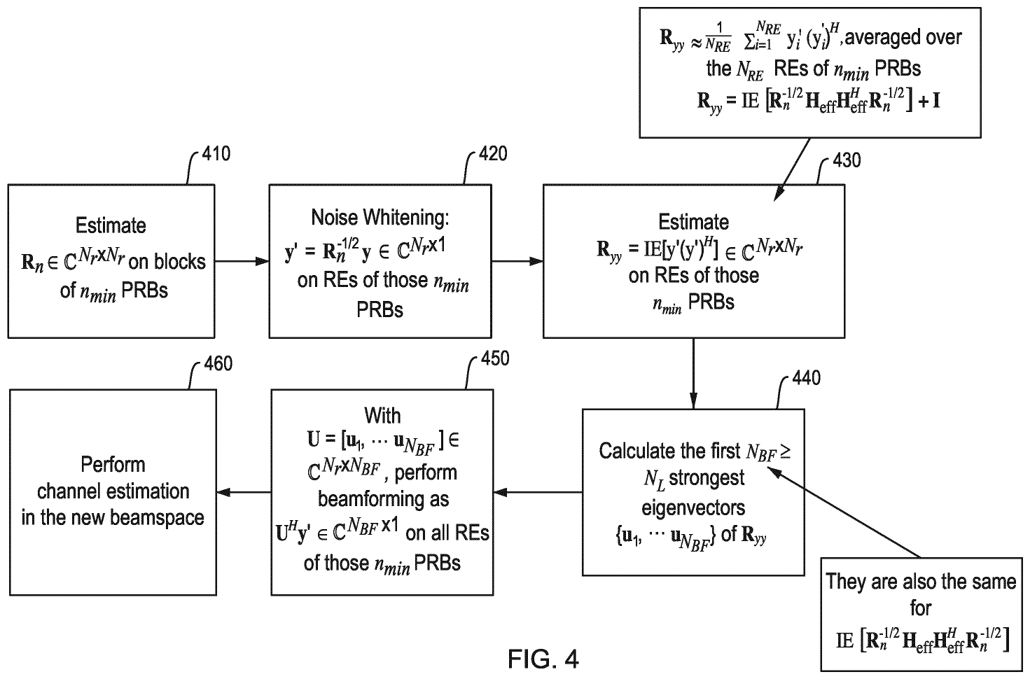

FIG. 4 illustrates a block diagram of a beamforming approach, according to certain embodiments. FIG. 4 may be viewed as a specific example implementation of the approach illustrated in FIG. 3. The approach of FIG. 4 may be suitable for a MU-MIMO system with Nᵣ transceivers (TRXs) at the gNB and Nᵤ co-scheduled users.

In such an approach, the signal model of Equation (1) may be used:

$$y = Hs + {n}_{I + N} \qquad Equation ( 1 )$$

where y∈ [symbol] ^{N}^{ᵣ}^{×1} is the received signal vector, H [symbol] [H₁, H₂, . . . , H_{N}_{ᵤ}] is the composite channel matrix with Hᵢ∈ [symbol] ^{N}^{ᵣ}^{×N}^{ₜ}^{⁽ⁱ⁾} being the channel matrix (to gNB) from user i equipped with Nₜ⁽ⁱ⁾ transmit antennas, s [symbol] [s₁^{T}, s₂^{T}, . . . , s_{N}_{ᵤ}^{T}]^{T} with sᵢ∈ [symbol] ^{N}^{ₜ}^{⁽ⁱ⁾}^{×1} being the i^{th} user's transmit vector after possible precoding, and n_{I+N}∈ [symbol] ^{N}^{ᵣ}^{×1} is the interference+AWGN (I+N) with a covariance matrix Rₙ. Further, wᵢ∈ [symbol] ^{N}^{ₜ}^{⁽ⁱ⁾}^{×N}^{ₗ}^{⁽ⁱ⁾} can be the precoding matrix for user i that transmits Nₗ⁽ⁱ⁾≤Nₜ⁽ⁱ⁾ streams (or layers) of data, and xᵢ∈ [symbol] ᵢ^{N}^{ₗ}^{⁽ⁱ⁾}_{×1} can be the data symbol vector with each entry taking values from a unit energy [symbol] ᵢ-QAM constellation.

With H_{eff} [symbol] [H₁w₁, H₂w₂, . . . , H_{N}_{ᵤ}w_{N}_{ᵤ}], the signal model of Equation can result:

$$y = {H}_{eff} x + {n}_{I + N} ⇒ {R}_{n}^{- 1 / 2} y = {R}_{n}^{- 1 / 2} {H}_{eff} x + n \qquad Equation ( 2 )$$

where n is the whitened noise with covariance equal to the identity matrix. The maximum-likelihood (ML) performance of the system may be dependent on ∥Rₙ^{-1/2}H_{eff}∥ because, as per Equation (3):

$${P}_{error} \leq {min}_{Δ x \neq 0} \{ k exp ( - {‖ ( {R}_{n}^{- \frac{1}{2}} {H}_{eff} ) Δ x ‖}^{2} ) \} \qquad Equation ( 3 )$$

where k is a constant and Δx is the difference between any two distinct transmitted symbol vectors. If a beamformer B∈ [symbol] ^{N}^{_{BF}}^{×N}^{ᵣ} is used, then according to Equation (4):

$$By = {BH}_{eff} x + {Bn}_{int + w} ⇒ {R}_{B}^{- 1 / 2} y = {R}_{B}^{- 1 / 2} {BH}_{eff} x + n \qquad Equation ( 4 )$$

where R_{B}=BRₙB^{H}∈ [symbol] ^{N}^{_{BF}}^{×N}^{_{BF}} can be the covariance of Bn_{int+w}. The ideal beamformer can be

$${B}^{*} = {U}^{H} {R}_{n}^{- 1 / 2} \qquad Equation ( 5 )$$

where U∈ [symbol] ^{N}^{ᵣ}^{×N}^{_{L}} can be the matrix whose columns are the first N_{L}(=number of Tx layers) left singular vectors of Rₙ^{-1/2}H_{eff} or, equivalently, the N_{L} dominant eigenvectors of Rₙ^{-1/2}H_{eff}H_{eff}^{H}Rₙ^{-1/2}.

The beamformer of Equation (5) may be considered an ideal beamformer because ∥U^{H}Rₙ^{-1/2}H_{eff}∥=∥Rₙ^{-1/2}H_{eff}∥ which is evident from the SVD of Rₙ^{-1/2}H_{eff}. In practice, it may be challenging to have a good estimate of Rₙ^{-1/2}H_{eff} due to the high-dimensionality.

Instead, the spatial covariance of Rₙ^{-1/2}y can be estimated across, for example, say nₘᵢₙ physical resource blocks (PRBs), and the N_{BF}≥N_{L} strongest eigenvectors of this covariance matrix can be used to form the beamforming matrix. For example, N_{BF}=2N_{L} may be a good number of beams to use.

Thus, as shown in FIG. 4, at 410, the cell can estimate Rₙ∈ [symbol] ^{N}^{ᵣ}^{×N}^{ᵣ} on blocks of nₘᵢₙ PRBs. Then, at 420, noise whitening can be performed, such that

$${y}^{′} = {R}_{n}^{- \frac{1}{2}} y ∈ {ℂ}^{{N}_{r} \times 1}$$

on REs of those of nₘᵢₙ PRBs.

Then, at 430, the cell can estimate

$${R}_{yy} = 𝔼 [ {y}^{{′ ( {y}^{′} )}^{H}} ] ∈ {ℂ}^{{N}_{r} \times {N}_{r}}$$

of those of nₘᵢₙ PRBs.

$${R}_{yy} \approx \frac{1}{{N}_{RE}} {\sum }_{i = 1}^{{N}_{RE}} {{{y}_{i}}^{′} ( {{y}_{i}}^{′} )}^{H} ,$$

averaged over the N_{RE} REs of nₘᵢₙ PRBs, where

$${R}_{yy} = 𝔼 [ {R}_{n}^{- \frac{1}{2}} {H}_{eff} {H}_{eff}^{H} {R}_{n}^{- \frac{1}{2}} ] + 1.$$

At 440, the cell can calculate the first N_{BF}≥N_{L} strongest eigenvectors {u₁, . . . u_{N}_{_{BF}}} of R_{yy}. They may also be the same for

$$𝔼 [ {R}_{n}^{- \frac{1}{2}} {H}_{eff} {H}_{eff}^{H} {R}_{n}^{- \frac{1}{2}} ] .$$

At 450, the cell may, with U={u₁, . . . uₙ_{_{BF}}}∈ [symbol] ^{N}^{ᵣ}^{×N}^{ᵣ}, perform beamforming as U^{H}y′∈ [symbol] ^{N}^{ᵣ}^{×1} on all REs of those nₘᵢₙ PRBs. At 460, the cell can perform channel estimation in the new beamspace.

The block-diagram of FIG. 4 also highlights why the approach of FIG. 4 may be a good practical approximation for Equation (5). Instead of obtaining the eigenvectors of Rₙ^{-1/2}H_{eff}H_{eff}^{H}Rₙ^{-1/2} for each resource element, instead the eigenvectors of [symbol] [Rₙ^{-1/2}H_{eff}H_{eff}^{H}Rₙ^{-1/2}] can be obtained, where the expectation may be obtained by averaging over both frequency and time within a transmission slot. For slow-moving users, this matrix may be close to Rₙ^{-1/2}H_{eff}H_{eff}^{H}Rₙ^{-1/2}.

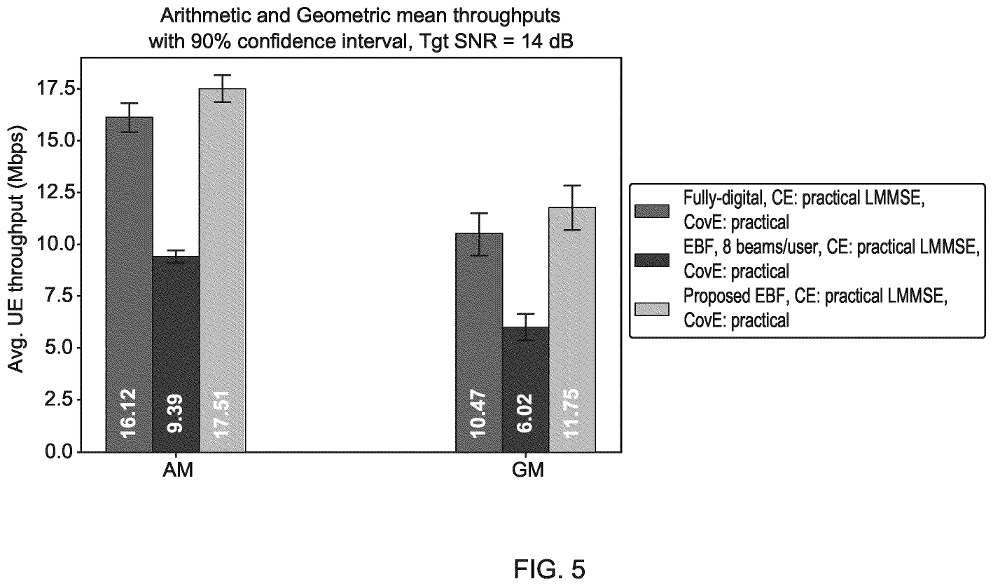

FIG. 5 illustrates simulation results of a simulation of certain embodiments. The following simulation parameters were used for performing a multi-cell, multi-link-level simulation (MCMLLS). The simulation considered a 21-cell, 210-UE setting with the following parameters. Site parameters were as follows: 7 sites, 3 cells/site, inter-site distance of 200 meters (m), and 210 users. Antenna parameters were as follows: cell antenna array 256 TRX (8×16×2) and UE antenna array 4-TRX (1×2×2). Channel parameters were as follows: channel model 38.901 Urban Micro, center frequency 7 GHz, 30 kHz sub-carrier spacing, 24 PRBs, and 8.64 MHz channel bandwidth (BW). Other parameters were as follows: target signal to noise ratio (SNR) in decibels (dB) was 14 dB, open loop power control fractional pathloss compensation factor was 0.85, maximum total output power per UE was 23 dBm, noise figure at cell was 0 dB, 5 user drops per target SNR, 100 slots per drop, 10 data symbols/slot, 0.5 ms slot duration, practical channel estimation using 12 pilots per layer per PRB, and practical I+N covariance estimation across all 24 PRBs using 480 samples.

The median number of layers/slot was found to be 13, with the maximum being 32, and the median number of co-scheduled users was found to be 8, with the maximum being 12. The results of the MCMLLS are shown in FIG. 5. The approach of 8 beams/user was used for the EBF method. This approach of 8 beams/user is an example of the method illustrated in FIG. 2. The fully-digital case corresponds to full antenna-array processing, without beamforming. The results demonstrate that certain embodiments may provide various benefits and/or advantages.

Certain embodiments may be used in 6G, where the base station may be equipped with a large antenna array and a large number of transceivers. Nevertheless, there is nothing that prevents usage of certain embodiments in other receivers, such as in 5G BS receivers.

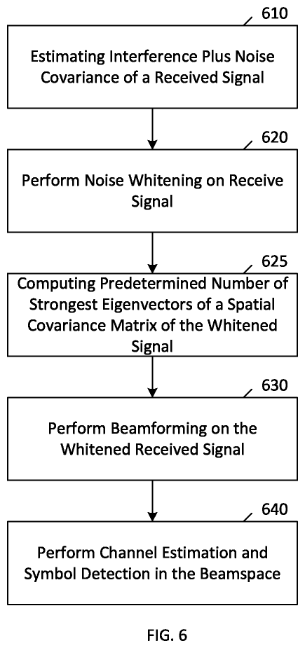

FIG. 6 illustrates an example flow diagram of a method for providing receiver processing, such as uplink receiver processing in massive multi-user multiple input multiple output systems, according to certain embodiments.

The method can include, at 610, estimating interference plus noise covariance of a received signal.

The method can also include, at 620, performing noise whitening of the received signal. The noise whitening can be spatial whitening. The estimating at 610 and performing noise whitening at 620 can correspond to 310 in FIG. 3. As shown in FIG. 6, the method can further include, at 625, computing a predetermined number of strongest eigenvectors of a spatial covariance matrix of the whitened received signal. The method can also include, at 623, estimating covariance of the noise-whitened received signal. The procedures at 623 and 625 can correspond to 320 and 330 in FIG. 3, respectively.

As shown in FIG. 6, the method can further include, at 630, performing beamforming on the whitened received signal. A beamforming matrix can be a complex-conjugate of the computed strongest eigenvectors. Thus, the procedures of 630 can correspond to 340 and 350 in FIG. 3. As shown in FIG. 6, the performing the beamforming at 630 can include left-multiplying the whitened received signal by the beamforming matrix. The performing the beamforming at 630 can include converting the whitened received signal to beamspace. The beamspace can have lower dimensionality than the received signal prior to beamforming. The beamforming can be configured to reject interference while preserving desired signal energy in a lower-dimensional space than before the beamforming.

The method can additionally include, at 640, performing channel estimation and symbol detection in the beamspace. In FIG. 3, procedure 360 can correspond to the performing channel estimation and symbol detection in the beamspace at 640.

It is noted that FIG. 6 is provided as one example embodiment of a method or process. However, certain embodiments are not limited to this example, and further examples are possible as discussed elsewhere herein.

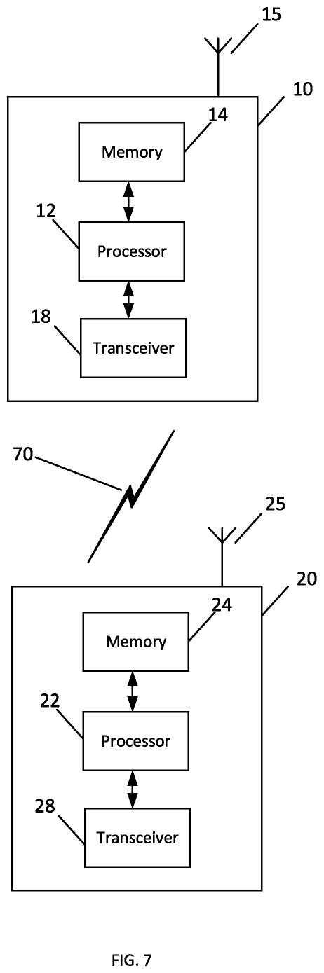

FIG. 7 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 7.

As illustrated in the example of FIG. 7, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 7, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 3-6, or any other method described herein. In some embodiments, as discussed herein, apparatus 10 may be configured to perform a procedure relating to providing receiver processing, such as uplink receiver processing in massive multi-user multiple input multiple output systems, for example.

FIG. 7 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7.

As illustrated in the example of FIG. 7, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 3-6, or any other method described herein. For example, in an embodiment, apparatus 20 may be controlled to perform a process relating to providing receiver processing, such as uplink receiver processing in massive multi-user multiple input multiple output systems, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may provide better user throughput performance compared to a full-antenna array-processing-based receiver. Under ideal conditions, for example availability of perfect CSI and I+N covariance matrix, the performance may be exactly the same, due to Equation (5), discussed above. In a practical setting, certain embodiments may outperform because certain embodiments may enable channel estimation to be performed in a lower-dimensional space, which can lead to more accurate estimation. Moreover, certain embodiments may outperform other EBF-based techniques because in certain embodiments the beamformer is an approximation of the ideal beamformer and effectively rejects the interference while other approaches may not.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

AE Antenna Element
BF BeamForming
BS Base Station
CE Channel Estimation
CovE Covariance Estimation
EBF Eigen BeamForming
gNB next generation NodeB
I+N Interference plus Noise
MCMLLS Multi-Cell, Multi-Link-Level simulation
ML Maximum-Likelihood
MU-MIMO Multi-User Multiple-Input Multiple-Output
PRB Physical Resource Block
RE Resource Element
SISO Single-Input Single-Output
SNR Signal-to-Noise Ratio
SVD Singular Value Decomposition
TRX Transceiver
UE User Equipment

1. An apparatus, comprising:
at least one processor; and
at least one memory
storing instructions that, when executed with the at least one processor, cause the apparatus at least to perform:
estimating interference plus noise covariance of a received signal at an antenna array;
performing noise whitening of the received signal; and
performing beamforming on the whitened received signal.

2. The apparatus of claim 1, wherein the instructions, when executed with the at least one processor, cause the apparatus at least to perform:
computing a predetermined number of strongest eigenvectors of a spatial covariance matrix of the whitened received signal.

3. The apparatus of claim 2, wherein a beamforming matrix comprises a complex-conjugate of the computed strongest eigenvectors, and wherein the instructions, when executed with the at least one processor, cause the apparatus to perform left-multiplying the whitened received signal with the beamforming matrix.

4. The apparatus of claim 1, wherein the instructions, when executed with the at least one processor, cause the apparatus to perform converting the whitened received signal to beamspace, wherein the beamspace has lower dimensionality than the received signal prior to beamforming.

5. The apparatus of claim 1, wherein the instructions, when executed with the at least one processor, cause the apparatus at least to perform:
performing channel estimation and symbol detection in the beamspace.

6. The apparatus of claim 1, wherein the instructions, when executed with the at least one processor, cause the apparatus to perform rejecting interference while preserving desired signal energy in a lower-dimensional space than before the beamforming.

7. The apparatus of claim 1, wherein the noise whitening comprises spatial whitening.

8. A method, comprising:
estimating interference plus noise covariance of a received signal at an antenna array;
performing noise whitening of the received signal; and
performing beamforming on the whitened received signal.

9. The method of claim 8, further comprising computing a predetermined number of strongest eigenvectors of a spatial covariance matrix of the whitened received signal.

10. The method of claim 9, wherein a beamforming matrix comprises a complex-conjugate of the computed strongest eigenvectors, and wherein the performing the beamforming comprises left-multiplying the whitened received signal with the beamforming matrix.

11. The method of claim 8, wherein the performing the beamforming comprises converting the whitened received signal to beamspace, wherein the beamspace has lower dimensionality than the received signal prior to beamforming.

12. The method of claim 8, further comprising performing channel estimation and symbol detection in the beamspace.

13. The method of claim 8, wherein the beamforming is configured to reject interference while preserving desired signal energy in a lower-dimensional space than before the beamforming.

14. The method of claim 8, wherein the noise whitening comprises spatial whitening.

15. (canceled)

16. (canceled)

17. (canceled)

18. (canceled)

19. (canceled)

20. (canceled)

21. (canceled)

22. A computer-program product encoded with instructions that, when executed in hardware, perform a process, the process comprising the method according to claim 8.

23. A non-transitory program storage device readable with an apparatus, tangibly embodying a program of instructions executable with the apparatus for performing operations according to claim 8.
